(19) United States
(12) Patent Application Publication
(10) Pub. No.: US 2017/0341702 A1
(43) Pub. Date: Nov. 30, 2017

(54) BICYCLE BRAKE

(71) Applicant: Yuan-Hung WEN, Chang Hua County (TW)

(72) Inventor: Yuan-Hung WEN, Chang Hua County (TW)

(21) Appl. No.: 15/472,635

(22) Filed: Mar. 29, 2017

(30) Foreign Application Priority Data
May 24, 2016 (TW) 105116037

(51) Int. Cl. B62L 1/14

(52) U.S. Cl. CPC B62L 1/14; B60Y 2304/07

(57) ABSTRACT

A bicycle brake is provided, including: a clamping arm, having a slide slot; a braking assembly, having an axle portion, the axle portion being slidably arranged within the slide slot; and an elastic member, abutting against the clamping arm and the axle portion so that the axle portion has a tendency to move toward a direction normally.

### BACKGROUND OF THE INVENTION

### Field of the Invention

The present invention relates to a brake, and more particularly to a bicycle brake.

### Description of the Prior Art

Conventionally, a bicycle brake brakes a bicycle through the friction between a brake shoe and a wheel rim.

However, in the prior art, when a user encounters emergencies, the brake shoe may lock the wheel rim (that is, the wheel rim is unrotatable), and the user may be unable to control the bicycle and fall down or get hurt. Usually, in the bicycle brake which has anti-lock braking function, a braking pad seat is disposed in a shell body, and a braking pad seat is positioningly disposed in the shell body via an engaging member which extends from the shell body, so it is hard for the user to replace components by himself/herself, and when the brake malfunctions, the whole brake needs to be replaced and use the braking pad seat which has the specifications to cooperate with the shell body. Therefore, it is resource-wasting and money-wasting to use this type of bicycle brake.

The present invention has arisen to mitigate and/or obviate the afore-described disadvantages.

### SUMMARY OF THE INVENTION

The major object of the present invention is to provide a bicycle brake which can prevent a brake from being locked and has a simple structure. In addition, the bicycle brake is cost-saving and easy to be assembled and disassembled.

To achieve the above and other objects, a bicycle brake is provided, including: a clamping arm, having a slide slot; a braking assembly, having an axle portion, the axle portion being slidably arranged within the slide slot; and an elastic member, abutting against the clamping arm and the axle portion so that the axle portion has a tendency to move toward a direction normally.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown view of the preferable embodiment of the present invention;

FIG. 3 is a drawing showing FIG. 1 from another perspective;

FIGS. 4 to 6 are drawings showing the preferable embodiment of the present invention in operation; and

FIGS. 7 to 10 are drawings showing another preferable embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

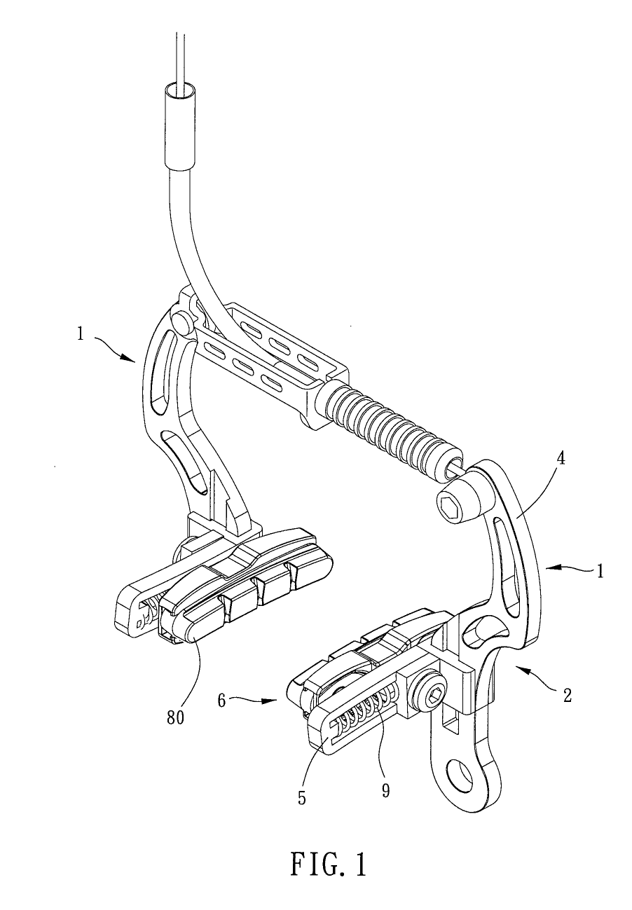

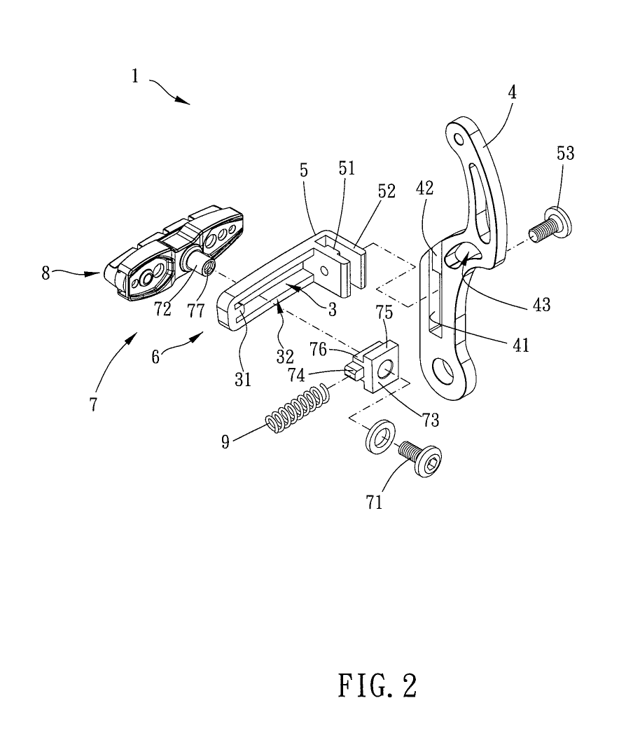

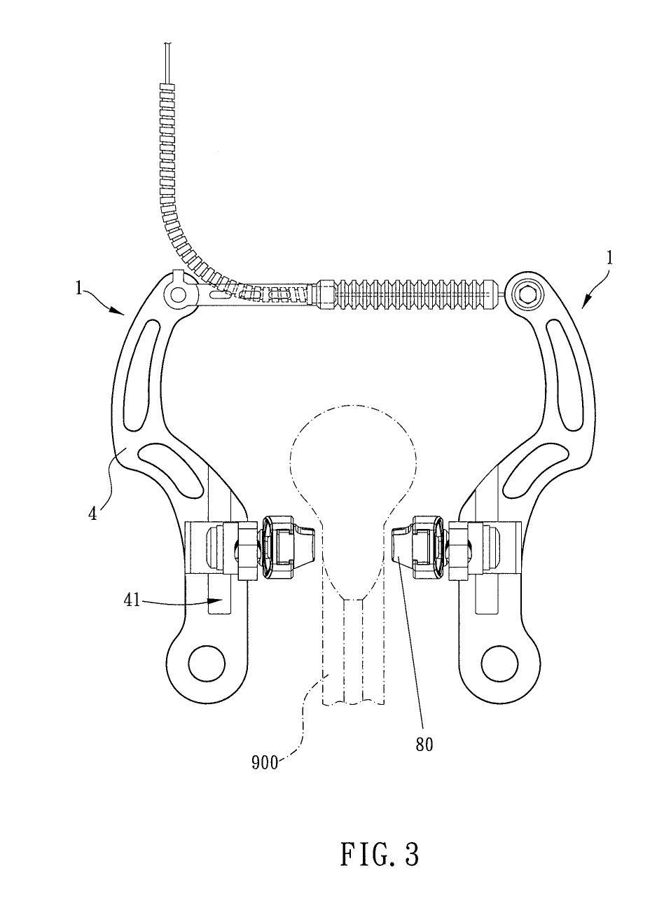

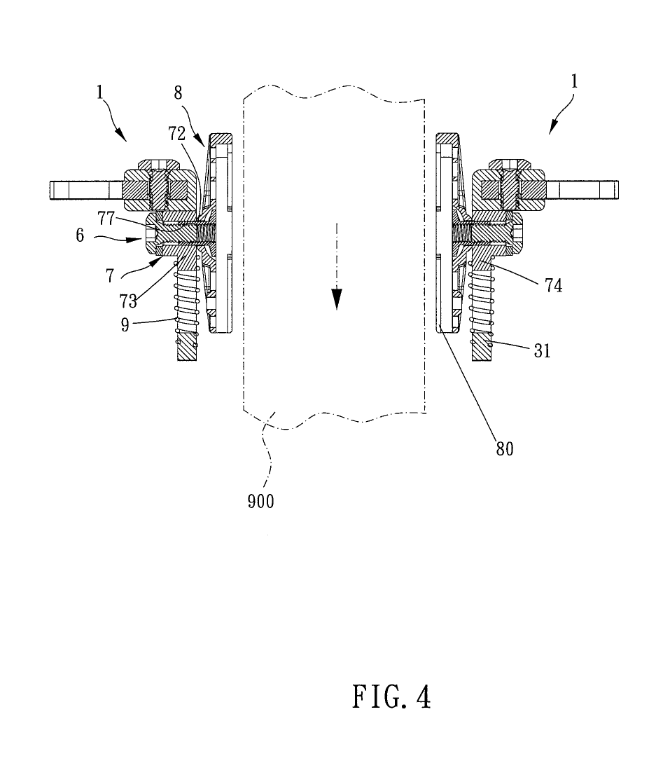

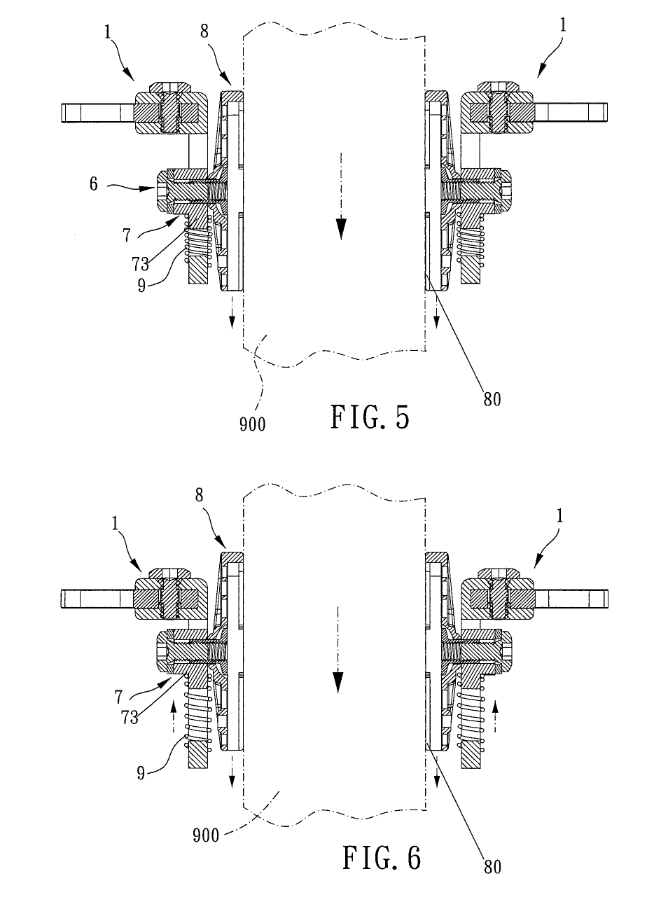

Please refer to FIGS. 1 to 6 for a first embodiment of the present invention. A bicycle brake 1 includes a clamping arm 2, a braking assembly 6 and an elastic member 9.

The clamping arm 2 has a slide slot 3. The braking assembly 6 has an axle portion 7, and the axle portion 7 is slidably arranged within the slide slot 3. The elastic member 9 abuts against the clamping arm 2 and the axle portion 7 so that the axle portion 7 has a tendency to move toward a direction normally. Thereby, when the braking assembly 6 compresses the elastic member 9, the elastic member 9 pushes the axle portion 7 back and makes the braking assembly 6 to brake intermittently so as to prevent the bicycle brake 1 from being locked.

In this embodiment, the restriction member 6 includes a braking pad seat 8, the braking pad seat 8 includes a restriction plate 80, the axle portion 7 includes an axle body 72 which is protrudingly arranged on the braking pad seat 8 and slidably arranged within the slide slot 3 and a movable base 73 which is connected to the axle body 72 and movable along the slide slot 3, the elastic member 9 abuts against and between a side wall of the slide slot 3 and the movable base 73, and the braking pad seat 8 and the movable base 7 are located by two opposite sides of the slide slot 3; therefore, the clamping arm 2 does not need to be provided additional structures for fixing the braking pad seat 8 (for example, a shell body covers a part of the braking pad seat to prevent the braking pad seat from being disengaged with the clamping arm), and the braking assembly 6 can be positioned on the rail body 5. The slide slot 3 is C-shaped and has a slot opening 32 opposite to the braking pad seat 8, the movable base 73 includes a blocking head 75 and a slidable block 76 which is connected to the blocking head 75, the slidable block 76 is disposed within the slide slot 3 and slideable along the slide slot 3, and the blocking head 75 blocks and abuts against a periphery of the slot opening 32 to prevent the movable base 7 from moving toward the braking pad seat 8 and from detaching. The axle portion 7 has a threaded portion 77, and a screwing member 71 is disposed through the movable base 73 and screwed with the threaded portion 77 to strengthen a stability. In addition, a tightness of the screwing member 71 can be adjusted to control the interaction between the elastic member 9 and the braking assembly 6 (for example but not limited thereto, increasing the tightness to elevate a threshold of a force needed to make the braking assembly 6 move).

The clamping arm 2 includes a main body 4 and a rail body 5 which is laterally connected to the main body 4, and the rail body 5 has the slide slot 3. The side wall of the slide slot 3 has a first protrusion 31, the movable base 73 has a second protrusion 74, the elastic member 9 is a coil spring, and two ends of the elastic member 9 are respectively sleeved on the first and second protrusions 31, 74 so that the elastic member 9 can be stably arranged within the slide slot 3. The main body 4 has a through slot 41 which is lateral to the slide slot 3, the rail body 5 has a guiding block 51, the guiding block 51 is disposed within the through slot 41 and adjustably positionable along the through slot 41, the guiding block 51 helps the rail body 5 to be maintained in the main body 4, and in actual use, the through slot 41 is for adjusting the rail body 5 to a relative position aligned with a wheel rim 900. The rail body 5 includes two clamping ears 52 parallel to each other, one of the two clamping ears 52 has the guiding block 51, the two clamping ears 52 clamp two opposite sides of the main body 4 and are positioned on the main body 4 via a fastening member 53, and the clamping ear 52 helps the rail body 5 to be stably positioned on the main body 4. The main body 4 further includes a rail groove 42 which communicates with the through slot 41 and opens laterally and at least one through structure 43. The guiding block 51 can slide through the rail groove 42 into the through slot 41, the two clamping ears 52 can approach each other through the fastening member 53 to clamp the main body 4 tightly, and at the same time, the fastening member 53 can prevent the guiding block 51 from being detached from the through slot 41. The at least one through structure 43 helps to decrease a weight of the main body 4.

In actual use, the clamping arm 2 is close to the wheel rim 900, the restriction plate of the braking pad seat 8 contacts the wheel rim 900, the braking pad seat 8 is driven toward a rotation direction of the wheel rim 900, the elastic member 9 is compressed and deforms, the braking assembly 6 moves along the rail body 5 toward the first protrusion 31, and when the flexibility of the elastic member 9 compressed is greater than a friction of the restriction plate and the wheel rim 900, the elastic member 9 pushes the removable base 7 back toward the two clamping ears 52; therefore, the restriction plate 80 can intermittently clamp the wheel rim 900 tightly instead of locking the wheel rim 900. The braking pad seat 8 is independently connected to the movable base 74 via the axle body 72 so that the braking pad seat 8 can use a regular brake seat to be engaged with the movable base (the regular brake seat usually has one said axle body), so when the braking pad seat 8 needs to be replaced, a user does not need to purchase a whole set of the bicycle brake 1 to replace the old one.

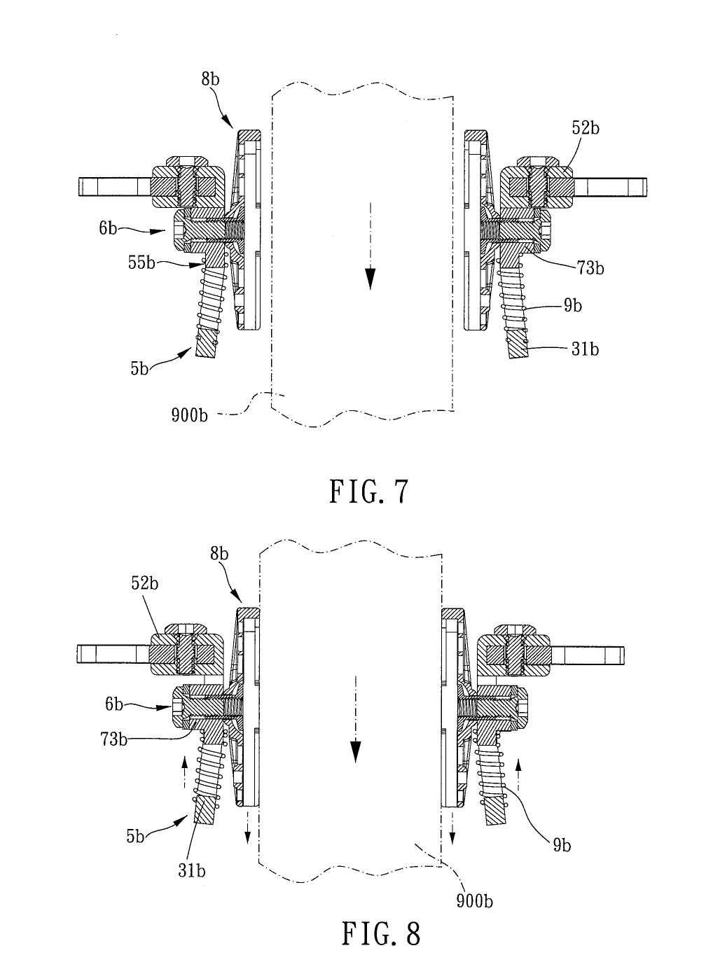

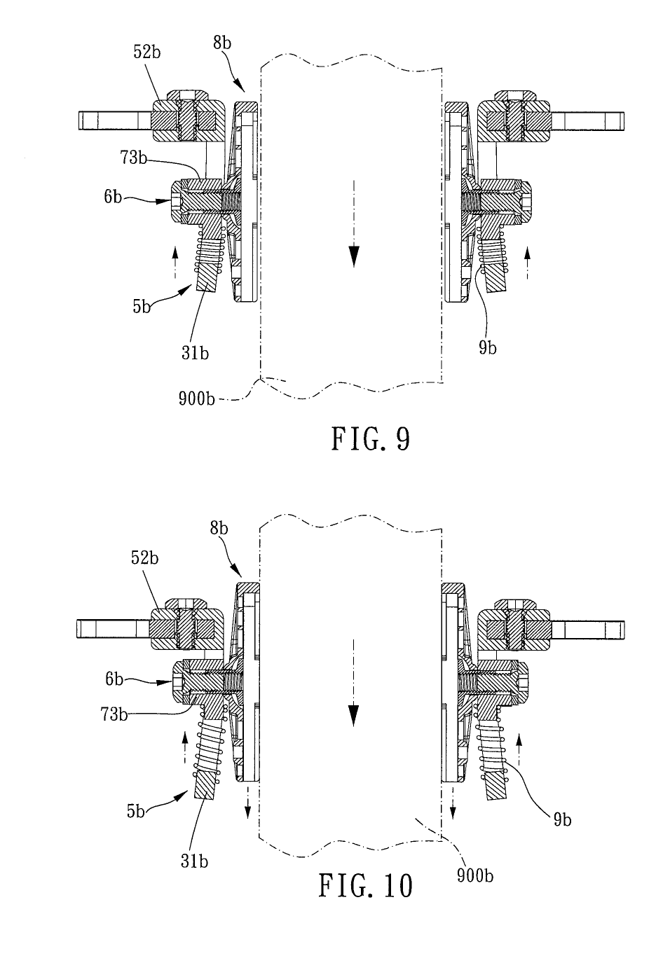

Please refer to FIGS. 7 to 10 for another embodiment, the rail body 5b has at least one turning point 55b and bends toward the movable base 73b so that the braking pad seat 8b approaches the first protrusion 31b and moves away from a wheel rim 900b simultaneously; thereby, the elastic member 9b can push the movable base 73b more easily toward the two clamping ears 52b so as to make the braking assembly 6b intermittently clamp the wheel rim 900b.

In other embodiments, the axle body and the movable base can be engaged with each other in other ways, for example but not limited to, tenoning, riveting or the like, as long as the braking pad seat and the movable base are located by the two opposite sides of the slide slot; the main body and the rail body may be engaged with each other in other ways; the rail way may be not curved as long as when the braking pad seat moves toward the first protrusion, the braking assembly can intermittently clamp the wheel rim; the first and second protrusions may be recessive structures for the elastic member to be arranged and restricted therein, and of course, the first and second protrusions may be not a way to restrict the elastic member as long as the elastic member can be stably arranged within the slide slot; the elastic member may also arranged on an end of the slide slot near the two clamping ears and move the movable base toward the two clamping ears normally.

Given the above, the bicycle brake prevents is prevented from being locked through an interaction relation between the elastic member and the movable base, the braking pad seat is detachably engaged with the movable base, the bicycle brake has a simple structure and lower manufacturing cost, and the bicycle brake is easy to be assembled or disassembled.

While we have shown and described various embodiments in accordance with the present invention, it should be clear to those skilled in the art that further embodiments may be made without departing from the scope of the present invention.

What is claimed is:

1. A bicycle brake, including:
a clamping arm, having a slide slot;
a braking assembly, having an axle portion, the axle portion being slidably arranged within the slide slot;
an elastic member, abutting against the clamping arm and the axle portion so that the axle portion has a tendency to move toward a direction normally.

2. The bicycle brake of claim 1, wherein the clamping arm includes a main body and a rail body which is laterally connected to the main body, and the rail body has the slide slot.

3. The bicycle brake of claim 2, wherein the main body has a through slot which is lateral to the slide slot, the rail body has a guiding block, and the guiding block is disposed within the through slot and adjustably positionable along the through slot.

4. The bicycle brake of claim 3, wherein the rail body includes two clamping ears parallel to each other, one of the two clamping ears has the guiding block, and the two clamping ears clamp two opposite sides of the main body and are positioned on the main body via a fastening member.

5. The bicycle brake of claim 1, wherein the braking assembly includes a braking pad seat, the axle portion includes an axle body which is protrudingly arranged on the braking pad seat and slidably arranged within the slide slot and a movable base which is connected to the axle body and movable along the slide slot, and the elastic member abuts against and between a side wall of the slide slot and the movable base.

6. The bicycle brake of claim 5, wherein the side wall of the slide slot has a first protrusion, the movable base has a second protrusion, the elastic member is a coil spring, and two ends of the elastic member are respectively sleeved on the first and second protrusions.

7. The bicycle brake of claim 5, wherein the axle portion has a threaded portion, and a screwing member is disposed through the movable base and screwed with the threaded portion.

8. The bicycle brake of claim 5, wherein the braking pad seat and the movable base are located by two opposite sides of the slide slot.

9. The bicycle brake of claim 5, wherein the slide slot is C-shaped and has a slot opening opposite to the braking pad seat, the movable base includes a blocking head and a slidable block which is connected to the blocking head, the slidable block is disposed within the slide slot and slideable along the slide slot, and the blocking head blocks and abuts against a periphery of the slot opening.

10. The bicycle brake of claim 8, wherein the slide slot is C-shaped and has a slot opening opposite to the braking pad seat, the movable base includes a blocking head and a slidable block which is connected to the blocking head, the slidable block is disposed within the slide slot and slideable along the slide slot, and the blocking head blocks and abuts against a periphery of the slot opening; the axle portion has a threaded portion, and a screwing member is disposed through the movable base and screwed with the threaded portion; the clamping arm includes a main body and a rail body which is laterally connected to the main body, and the rail body has the slide slot; the side wall of the slide slot has a first protrusion, the movable base has a second protrusion, the elastic member is a coil spring, and two ends of the elastic member are respectively sleeved on the first and second protrusions; the main body has a through slot which is lateral to the slide slot, the rail body has a guiding block, and the guiding block is disposed within the through slot and adjustably positionable along the through slot; the rail body includes two clamping ears parallel to each other, one of the two clamping ears has the guiding block, and the two clamping ears clamp two opposite sides of the main body and are positioned on the main body via a fastening member; the main body further includes a rail groove which communicates with the through slot and opens laterally and at least one through structure; the rail body has at least one turning point and bends toward the removable base.
